(19) United States
(12) Patent Application Publication
(10) Pub. No.: US 2009/0085254 A1
(43) Pub. Date: Apr. 2, 2009

(54) Laser scoring with flat profile beam

(76) Inventors: Anatoli Anatolyevich Abramov, Painted Post, NY (US); Weiwei Luo, Painted Post, NY (US); Qi Wu, Painted Post, NY (US); Wei Xu, Painted Post, NY (US); Naiyue Zhou, Painted Post, NY (US)

Correspondence Address: CORNING INCORPORATED, SP-TI-3-1, CORNING, NY, 14831, US

(21) Appl. No.: 11/904,697

(22) Filed: Sep. 28, 2007

(51) Int. Cl. B29C 35/08

(52) U.S. Cl. 264/400

(57) ABSTRACT

Disclosed are systems and methods for scoring glass sheets. A laser beam can be generated having a substantially uniform peak energy density along at least a portion of its length. The laser beam is moved across the glass sheet to create a score line. Further, the glass sheet can be separated along the score line. In some aspects, the laser beam is bimodal and comprises approximately 60-70% TEM00 mode and approximately 30-40% TEM01* mode.

### BACKGROUND OF THE INVENTION

1. Field of the Invention

The present invention relates to systems and methods for scoring and/or separating glass sheets comprising a laser beam having a flat profile.

2. Technical Background

In the past, several different methods and techniques have been used to separate glass sheets. Widely used methods include the use of lasers to score and/or separate glass sheets. The laser beam is moved across the glass sheet and creates a temperature gradient on the surface of the glass sheet, which is enhanced by a coolant (such as a gas or liquid) that follows the laser beam at some distance. Specifically, the heating of the glass sheet by the laser and the cooling of the glass sheet by the coolant creates stresses in the glass sheet. In this manner, a score line is created along the glass sheet. The glass sheet can then be separated into two smaller sheets by separating the glass sheet along the score line.

Considerable efforts have been dedicated to developing systems and methods for scoring glass sheets with lasers, particularly the glass sheets that are used in the production of flat panel displays (such as LCD). In order to score glasses having low expansion coefficients at a high scoring speed, lasers having very high power levels are needed. However, the laser power needed often approaches or exceeds the power level of the sealed-tube CO₂ lasers that are commonly used today.

Approaches have been taken to alter the profile of laser beams in order to increase scoring speeds. Standard laser scoring uses TEM₀₀ mode, which results in a classic Gaussian beam. Donut-shaped, or “D-mode” profiles have also been developed and have resulted in somewhat increased scoring speeds. Although these modes allow scoring glass at relatively high speeds, further improvement of the efficiency of the process, namely higher scoring speeds at lower laser power, is still required.

Thus, there is a need in the art for methods and systems for scoring sheets of glass at a high scoring speed, while producing sufficient stress in the glass sheets for scoring with the use of lower power lasers.

### SUMMARY OF THE INVENTION

The present invention provides systems and methods for scoring and/or separating glass sheets. In one aspect, a method for scoring a glass sheet is provided that comprises moving a laser beam across the glass sheet to create a score line. The laser beam has an energy density profile and, in one aspect, has a substantially uniform peak energy density along at least a portion of its length. In yet another aspect, the laser beam can be bimodal and comprise approximately 60-70% TEM00 mode and approximately 30-40% TEM01* mode. The method can further comprise separating the glass sheet along the score line. The laser beam can be generated by a CO₂ laser, according to various aspects.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed and/or as claimed.

### BRIEF DESCRIPTION OF THE DRAWINGS

FIG. 1 illustrates the intensity profile of a laser beam of TEM00 mode.

FIG. 2 illustrates the intensity profile of a laser beam of TEM01* mode.

FIG. 3 illustrates the intensity profile of a laser beam of standard D-mode (60%/40% blend of TEM01*/TEM00).

FIG. 4 illustrates the intensity profile of a standard D-mode laser beam generated by a CO₂ laser.

FIG. 5 illustrates the mode intensity distribution of the standard D-mode laser beam intensity profile of FIG. 4.

FIG. 6 is a graphical model of an intensity profile of a standard D-mode laser beam.

FIG. 7 is a graphical model of an intensity profile of a flat-top D-mode laser beam, according to one aspect of the present invention.

FIG. 8 is a graphical illustration of glass surface temperature (T) along a score line for standard D-mode and flat-top D mode laser beams, according to another aspect of the present invention.

### DETAILED DESCRIPTION

The following description of the invention is provided as an enabling teaching of the invention in its best, currently known embodiment. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used herein, the singular forms “a,” “an” and “the” include plural referents unless the context clearly dictates otherwise. Thus, for example, reference to a glass sheet includes embodiments having two or more such glass sheets unless the context clearly indicates otherwise.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

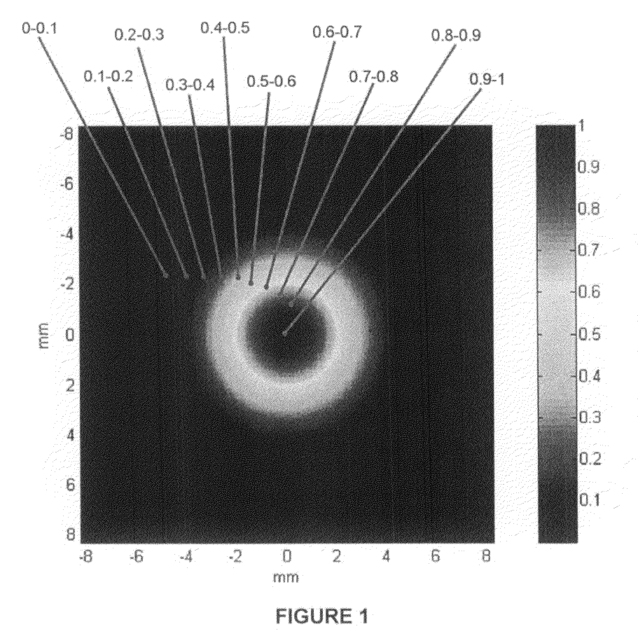

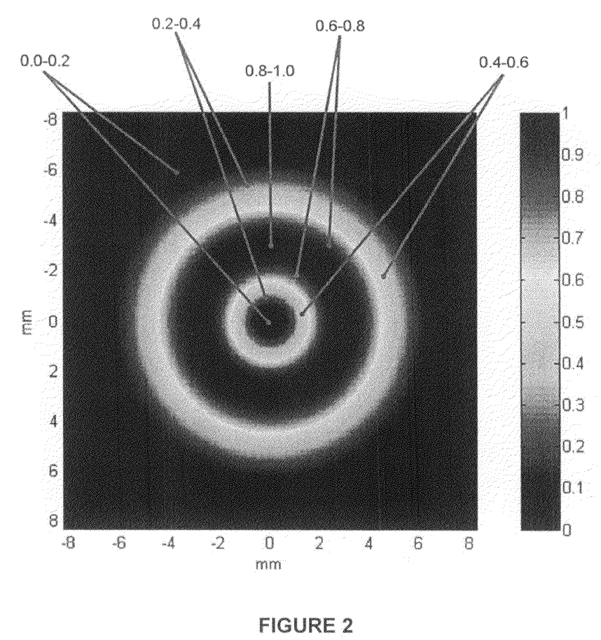

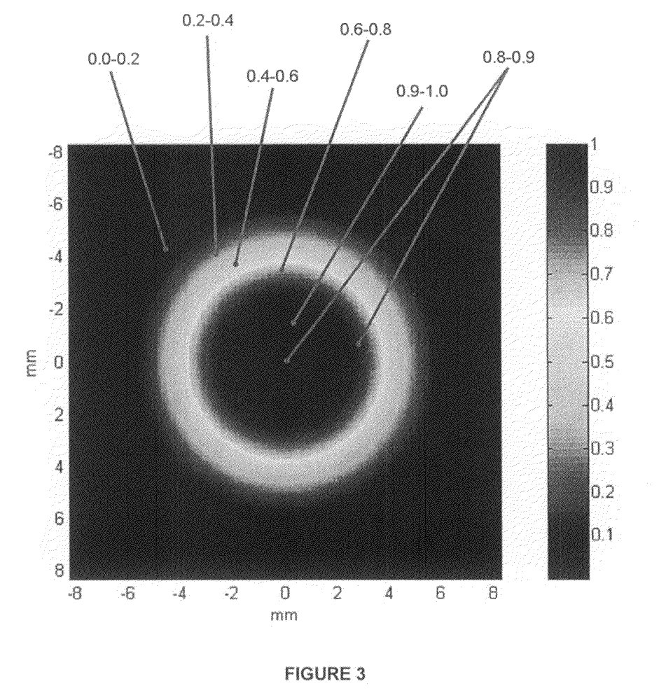

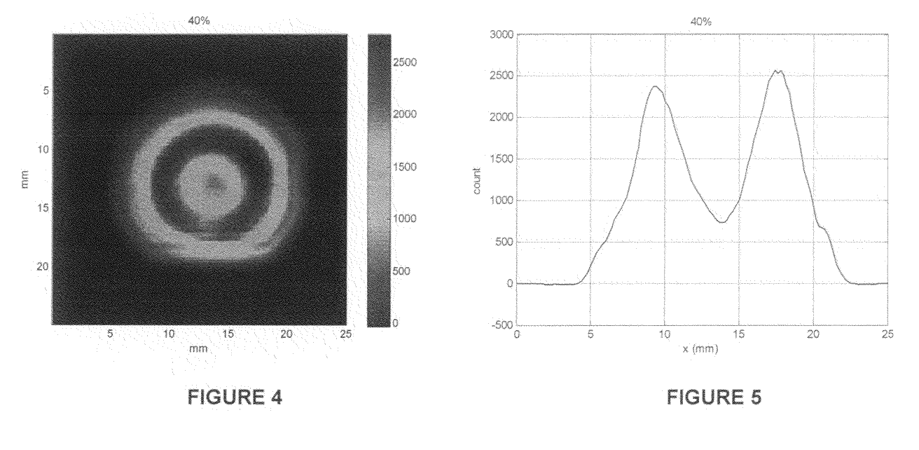

As briefly summarized above, the present invention provides methods and systems for scoring glass sheets, such as planar glass sheets. Standard laser modes include TEM00 mode (Gaussian or “S” mode), TEM01* mode (of 2 polarizations TEM01 and TEM10 modes), and standard D-mode (blend of approximately 60% TEM01* mode and 40% TEM00 mode). The mode intensity profiles of these modes, respectively, as produced by a CO₂ laser are illustrated in FIGS. 1-3. The intensity (or energy density) profile and intensity distribution of a standard D-mode laser produced by the laser, as measured by a Spiricon laser beam profile meter, are shown in FIGS. 4-5, respectively. As can be seen, standard D-mode with a maximum 40% content of TEM00 results in two distinctive peaks and a central dip.

According to one aspect of the present invention, a laser is provided that is configured to produce a laser beam with an energy density profile that has a substantially uniform peak energy density along at least a portion of its length. In a further aspect, the laser beam can be bimodal, such as but not limited to a bimodal laser beam comprising TEM00 and TEM01* modes. In a particular aspect, the ratio of TEM00 and TEM01* modes is approximately 60 to 70% TEM00 mode and approximately 30 to 40% TEM01*. For example, the ratio can be: 60%/40%, 65%/35%, or 70%/30% TEM00 to TEM01*, respectively, as well as other ratios.

In accordance with various aspects, a method is provided for scoring one or more planar glass sheets. The method can comprise moving a laser beam across the glass sheet(s) to create a score line. As described above, the laser beam in various aspects has an energy density profile that has a substantially uniform peak energy density along at least a portion of it length. In a further aspect, the laser beam can be bimodal and comprise approximately 60-70% TEM00 and approximately 30-40% TEM01* modes.

According to various aspects of the present invention, methods are provided for separating one or more planar glass sheets. Separating a planar glass sheet comprises, in one aspect, moving a laser beam across the glass sheet to create a score line and separating the glass sheet along the score line. A laser beam having a substantially uniform peak density along at least a portion of its length can be used to create a score line. Further, the laser beam can be bimodal and comprise approximately 60-70% TEM00 and approximately 30-40% TEM01* modes. Separating the glass sheet can be achieved by mechanical bending of the glass sheet after scoring. Optionally, separation can be achieved by moving a second laser beam along the glass sheet, following the first laser beam that creates the score line. In yet another aspect, the first laser beam can effect full separation in the glass sheet by creating a deep scoring line that propagates through the thickness of the glass. Other methods of separating the glass sheet are contemplated and considered to be within the scope of the present invention.

In one aspect, the laser beam can be generated by a CO₂ laser. Optionally, the laser beam can be generated by a laser having a power of between about 200 and 800 W. In a further aspect, the laser beam can be generated by a laser having a power of between about 450 and 550 W. In a particular aspect, a CO₂ laser having a power of about 500 W can be used to generate the laser beam. As described further below, use of a laser beam having a substantially uniform peak energy density (a “flat-top profile” laser beam) can result in increased efficiency in scoring the glass sheet. Thus, the laser beam in one aspect can be generated by any laser of sufficient power to achieve a desired scoring speed and/or temperature gradient along the surface of the glass sheet.

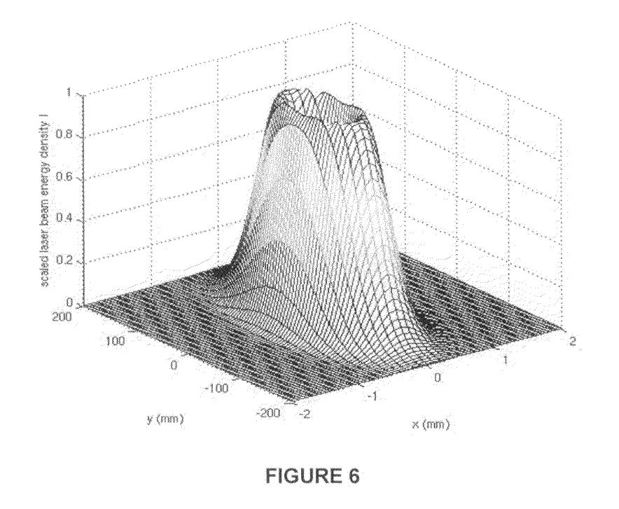

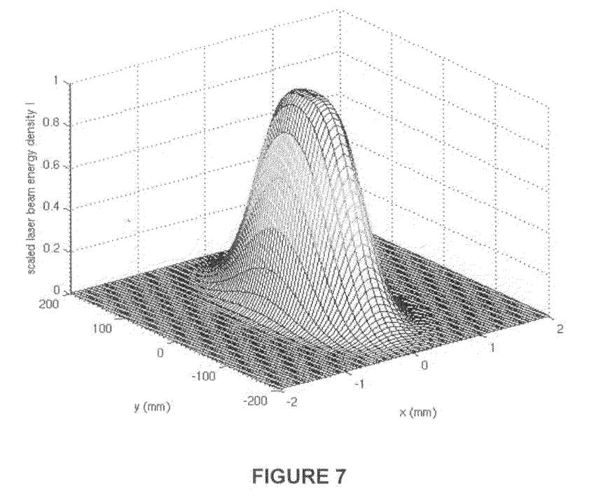

A laser beam generated in accordance with various aspects of the present invention has a substantially uniform peak energy density along at least a portion of its length, such as illustrated in FIG. 7, for example. The substantially uniform peak energy density can be compared with the energy density of a standard D-mode laser beam, such as shown in FIG. 6 (showing the donut-shaped energy density profile with a substantial dip in the energy density proximate the center of the laser beam). With further reference to FIG. 7, the energy density profile of a laser beam can have a longer length than its corresponding width. For example, the laser beam energy density profile can be approximately 1 to 2 mm wide and approximately 250 to 400 mm long.

In various aspects, a beam can be generated having an energy density profile characterized by the equation:

$$l = A [ {e}^{- 2 ( \frac{{x}^{2}}{{ω}_{x}^{2}} + \frac{{y}^{2}}{{ω}_{y}^{2}} )} + B ( \frac{{x}^{2}}{{ω}_{x}^{2}} + \frac{{y}^{2}}{{ω}_{y}^{2}} ) {e}^{- 2 ( \frac{{x}^{2}}{{ω}_{x}^{2}} + \frac{{y}^{2}}{{ω}_{y}^{2}} )} ]$$

where: I is the laser beam energy density, ωₓ is a beam width parameter, ω_{y} is a beam length parameter, and A and B are constants to determine the shape and energy density of the laser beam. In a further aspect, A/B equals 1/2.

In various aspects, the laser beam can be moved across the glass sheet at a predetermined scoring speed. The scoring speed can vary depending on the power of the laser, the coefficient of thermal expansion and the module of elasticity of the glass being scored. In a particular aspect, the step of moving the laser beam comprises moving the laser beam at a speed of between about 500 and 1000 mm/sec. The scoring speed can be, for example, 750 mm/sec.

Lastly, it should be understood that while the present invention has been described in detail with respect to certain illustrative and specific embodiments thereof, it should not be considered limited to such, as numerous modifications are possible without departing from the broad spirit and scope of the present invention as defined in the appended claims.

### EXAMPLES

To further illustrate the principles of the present invention, the following examples are put forth so as to provide those of ordinary skill in the art with a complete disclosure and description of how the ceramic articles and methods claimed herein can be made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred.

An experiment was conducted to score flat glass sheets using a standard D-mode laser beam and a bimodal laser beam having 60-70% TEM00 mode and 30-40% TEM01* mode, as described herein with regard to various aspects of the present invention. The experimental conditions included a scoring speed of approximately 750 mm/sec, a laser power of approximately 500 W, and a coolant flow rate of 10-14 ccm. The beams generated had an energy density profile characterized by the equation:

$$l = A [ {e}^{- 2 ( \frac{{x}^{2}}{{ω}_{x}^{2}} + \frac{{y}^{2}}{{ω}_{y}^{2}} )} + B ( \frac{{x}^{2}}{{ω}_{x}^{2}} + \frac{{y}^{2}}{{ω}_{y}^{2}} ) {e}^{- 2 ( \frac{{x}^{2}}{{ω}_{x}^{2}} + \frac{{y}^{2}}{{ω}_{y}^{2}} )} ]$$

where: I is the laser beam energy density, ωₓ is a beam width parameter, ω_{y} is a beam length parameter, and A and B are constants to determine the shape and energy density of the laser beam. For the standard D-mode laser beam, the A/B ratio was 1/18, and resulted in a substantially donut-shaped intensity profile. For the latter laser beam (60-70% TEM00 mode and 30-40% TEM01* mode) an A/B ratio of 1/2 was used to generate a substantially flat-top intensity profile.

FIG. 8 shows the results of this experiment and illustrates the temperature distribution along a score line obtained by the standard D-mode laser beam and in the latter case of the flat-top profile mode. FIG. 8 illustrates that the flat-top profile mode provides more uniform heating of the glass sheet, as well as faster heating to a higher temperature, as compared to the standard D-mode laser.

It was determined that as long as the maximum temperature achieved with the flat-top profile beam exceeds the temperature required for a stable scoring process, laser power can be reduced, such as by about 20-25%. Stress calculations performed using ANSYS FEA software showed that because the flat-top profile beam leads to higher glass surface temperature, it also generates higher transient stress at the same laser power as the standard D-mode laser beam. Thus, it was determined that using a lower-power laser to generate a flat-top profile beam would generate equivalent stresses as the standard D-mode beam generated by a laser of higher power.

1. A method for separating a planar glass sheet, comprising:
moving a laser beam across the glass sheet to create a score line, wherein the laser beam has an energy density profile that has a substantially uniform peak energy density along at least a portion of its length; and
separating the glass sheet along the score line.

2. The method of claim 1, wherein the laser beam is bimodal and comprises approximately 60-70% TEM00 mode and approximately 30-40% TEM01* mode.

3. The method of claim 2, wherein the laser beam comprises approximately 65% TEM00 mode and approximately 35% TEM01* mode.

4. The method of claim 2, wherein the laser beam is generated by a laser having an output coupler, the method further comprising modifying the output coupler to achieve the ratio of approximately 60-70% TEM00 mode and approximately 30-40% TEM01* mode.

5. The method of claim 1, wherein the laser beam is generated by a CO₂ laser.

6. The method of claim 5, wherein the laser has a power of between about 200 and 800 W.

7. The method of claim 6, wherein the laser has a power of about 500 W.

8. The method of claim 1, wherein the step of moving the laser beam comprises moving the laser beam at a speed of between about 500 and 1000 mm/sec.

9. The method of claim 8, wherein the step of moving the laser beam comprises moving the laser beam at a speed of approximately 750 mm/sec.

10. The method of claim 1, wherein the laser beam has an energy density profile characterized by the equation:
$$l = A [ {e}^{- 2 ( \frac{{x}^{2}}{{ω}_{x}^{2}} + \frac{{y}^{2}}{{ω}_{y}^{2}} )} + B ( \frac{{x}^{2}}{{ω}_{x}^{2}} + \frac{{y}^{2}}{{ω}_{y}^{2}} ) {e}^{- 2 ( \frac{{x}^{2}}{{ω}_{x}^{2}} + \frac{{y}^{2}}{{ω}_{y}^{2}} )} ]$$
where:
I is the laser beam energy density,
ω_{X} is a beam width parameter,
ω_{y} is a beam length parameter,
A and B are constants to determine the shape and energy density of the beam, and
A/B equals 1/2.

11. The method of claim 10, wherein the energy density profile of the laser beam is approximately 1 to 2 mm wide and approximately 250 to 400 mm long.

12. A method for scoring a planar glass sheet comprising:
moving a laser beam across the glass sheet to create a score line, wherein the laser beam has an energy density profile that has a substantially uniform peak energy density along at least a portion of its length.

13. The method of claim 12, wherein the laser beam is bimodal and comprises approximately 60-70% TEM00 mode and approximately 30-40% TEM01* mode.

14. The method of claim 13, wherein the laser beam comprises approximately 65% TEM00 mode and approximately 35% TEM01* mode.

15. The method of claim 13, wherein the laser beam is generated by a laser having an output coupler, the method further comprising modifying the output coupler to achieve the ratio of approximately 60-70% TEM00 mode and approximately 30-40% TEM01* mode.

16. The method of claim 12, wherein the step of moving the laser beam comprises moving the laser beam at a speed of between about 500 and 1000 mm/sec.

17. The method of claim 12, wherein the laser beam has an energy density profile characterized by the equation:
$$l = A [ {e}^{- 2 ( \frac{{x}^{2}}{{ω}_{x}^{2}} + \frac{{y}^{2}}{{ω}_{y}^{2}} )} + B ( \frac{{x}^{2}}{{ω}_{x}^{2}} + \frac{{y}^{2}}{{ω}_{y}^{2}} ) {e}^{- 2 ( \frac{{x}^{2}}{{ω}_{x}^{2}} + \frac{{y}^{2}}{{ω}_{y}^{2}} )} ]$$
where:
I is the laser beam energy density,
ωₓ is a beam width parameter,
ω_{y} is a beam length parameter,
A and B are constants to determine the shape and energy density of the beam, and
A/B equals 1/2.

18. The method of claim 16, wherein the energy density profile of the laser beam is approximately 1 to 2 mm wide and approximately 250 to 400 mm long.

19. The method of claim 12, further comprising separating the glass sheet along the score line.

20. The method of claim 12, wherein the laser beam is generated by a CO₂ laser.
